(19) United States
(12) Patent Application Publication
(10) Pub. No.: US 2025/0034291 A1
(43) Pub. Date: Jan. 30, 2025

(54) IMIDAZOLIUM-BASED ZWITTERIONIC POLYMER

(71) Applicant: CORNELL UNIVERSITY, Ithaca, NY (US)

(72) Inventors: Rong YANG, Ithaca, NY (US); Pengyu CHEN, Ithaca, NY (US)

(73) Assignee: CORNELL UNIVERSITY, Ithaca, NY (US)

(21) Appl. No.: 18/705,486

(22) PCT Filed: Nov. 14, 2022
(86) PCT No.: PCT/US2022/079800

§ 371 Date: Apr. 26, 2024

(51) Int. Cl. C08F 8/36; C08F 2/34; C08F 226/06; C08J 7/06; C08J 7/16; C09D 5/00; C09D 139/04

(52) U.S. Cl. CPC C08F 8/36; C08F 2/34; C08F 226/06; C08J 7/065; C08J 7/16; C09D 5/00; C09D 139/04

(57) ABSTRACT

Provided herein is a solid zwitterionic copolymer comprising repeat units of formulas (I) and (II). Compositions and articles comprising the copolymer are also provided, as are methods of making and using the copolymer. For example, layers of the copolymer find use in protecting a substrate from viral contamination, decreasing, reducing, or inhibiting viral proliferation on a substrate, and deactivating a virus on a substrate.

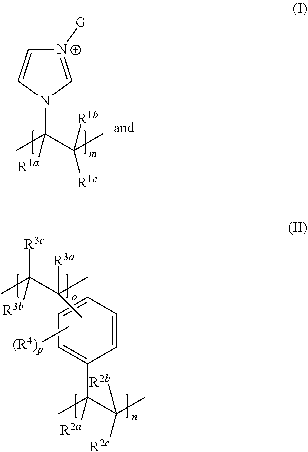

### CROSS REFERENCE TO RELATED APPLICATIONS

This application claims priority to U.S. provisional application No. 63/263,999, filed on Nov. 12, 2021, the entire contents of which are hereby incorporated by reference herein.

### GOVERNMENT LICENSE RIGHTS

This invention was made with government support under: (i) N00014-20-1-2418 awarded by the Office of Naval Research; and (ii) NIHDC016644 awarded by the National Institutes of Health. The government has certain rights in the invention.

### BACKGROUND

The ongoing pandemic outbreak due to Coronavirus disease of 2019 (COVID-19), one of the most dangerous pandemics in human history, has caused millions of deaths and transformed the way of life. Fomite transmission, i.e., the transmission of SARS-CoV-2 via contaminated surfaces, namely fomite surfaces, has been considered a cause for community spread, which in turn caused a huge economic impact. By the end of 2020, global sales of surface disinfectant amounted to $4.5 billion, with the New York Metropolitan Transit Authority (MTA) alone spending $484 million on COVID-19 response. The emerging variants of SARS-CoV-2 that are highly lethal and transmittable suggest that the virus will likely become a lasting threat to the public health, calling for novel materials that can resist the adhesion of viruses or deactivate them for the long-term health, public safety, and economic benefits.

A critical challenge that limited the development of a long-term solution to fomite transmission is the ubiquity of potential fomites. Any surface, ranging from that of medical instruments to public facilities, and from industrial equipment to personal electronics, used under dry ambient conditions or in a wetted state (e.g., the conveyer belt in food processing facilities), can become a fomite. That ubiquity requires that antiviral materials must be applied in a substrate-independent and conformal manner (e.g., onto plastic wares, fabrics, porous membranes, etc.), and that they remain effective under ambient or wetted conditions.

Furthermore, few studies to date have reported coatings with antiviral efficacy against coronaviruses. While a number of materials have been discovered to inactivate viruses upon contact (e.g., metal and inorganic materials based on their toxicity and/or ability to generate reactive oxygen species (ROS), polyelectrolytes, and photosensitizers), their antiviral efficacy was often proven using Influenza A virus or bacteriophages, which bear little resemblance to the SARS-CoV-2 (14). As a result, their reported antiviral efficacies may not be extrapolated to SARS-CoV-2 due to the unique architecture of coronaviruses. The emerging nanomaterials (e.g., Cu-alloy and nanoparticles of metal oxide) that demonstrated deactivation of coronavirus often require incubation of the viruses with the materials to achieve the antiviral effect, a prerequisite that is challenging to meet in most scenarios to stop fomite-mediated transmission.

Thus, a need exists for improved materials that offer a long-term solution to fomite transmission.

While certain aspects of conventional technologies have been discussed to facilitate disclosure of the invention, the Applicant in no way disclaims these technical aspects, and it is contemplated that the claimed invention may encompass one or more of the conventional technical aspects discussed herein.

In this application, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY

Briefly, the present invention relates to novel imidazolium-based zwitterionic polymers. Embodiments of the present invention satisfy the need for, inter alia, improved materials that offer a long-term solution to fomite transmission.

In a first aspect, the invention provides a solid zwitterionic copolymer comprising repeat units of formulas (I) and (II):

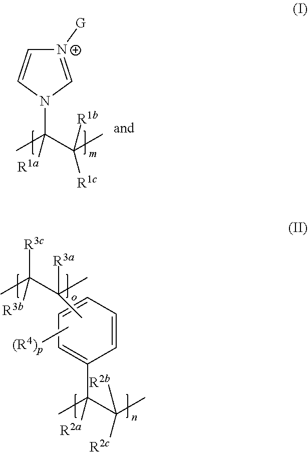

wherein
G is a moiety comprising at least one negatively charged functional group;
R^{1a}, R^{1b}, and R^{1c} are each independently selected from hydrogen, alkyl, phenyl, halo, hydroxyl, amino, nitro, and cyano;
R^{2a}, R^{2b}, and R^{2c} are each independently selected from hydrogen, alkyl, phenyl, halo, hydroxyl, amino, nitro, and cyano;
R^{3a}, R^{3b}, and R^{3c} are each independently selected from hydrogen, alkyl, phenyl, halo, hydroxyl, amino, nitro, and cyano;
R⁴ is in each instance independently selected from alkyl, phenyl, halo, hydroxyl, amino, nitro, and cyano;
m is an integer that is ≥1;
n is an integer that is ≥1;
o is an integer that is ≥1; and
p is an integer that is 0-4.

In a second aspect, the invention provides a composition comprising the copolymer according to the first aspect of the invention, including any embodiment or combination of embodiments thereof.

In a third aspect, the invention provides an article comprising the copolymer according to the first aspect of the invention or the composition according to the second aspect of the invention.

In a fourth aspect, the invention provides a method of making the copolymer according to the first aspect of the invention (or the composition according to the second aspect of the invention, or the article according to the third aspect of the invention), said method comprising:
placing a substrate in an iCVD reactor under vacuum condition;
flowing into the reactor in parallel or in sequence a plurality of materials comprising:
   an inert carrier gas;
   an initiator;
   a first monomer that is the source of the imidazole moiety in the formula (I) repeat units; and
   a second monomer that is the source of the formula (II) repeat units;
      thereby forming a polymer on the substrate via iCVD; and
      exposing the polymer to a negatively charged functional moiety, thereby forming the copolymer.

In a fifth aspect, the invention provides a method of
protecting a substrate from viral contamination; or
decreasing, reducing, or inhibiting viral proliferation on a substrate; or
deactivating a virus on a substrate;
   said method comprising applying a layer of the copolymer according to the first aspect of the invention on a substrate.

Various inventive embodiments represent a long-term solution to reduce fomite transmission by providing a copolymer (e.g., as an antiviral material) that: (i) could be applied in a substrate-independent and conformal manner, (ii) demonstrates efficacy against coronaviruses, (iii) deactivates viruses without the need for incubation with medium (e.g., by demonstrating deactivation of viruses in aerosols, a main medium for fomite-mediated disease spreading), and (iv) remains effective under dry ambient or wetted conditions.

These and other objects, features, and advantages of this invention will become apparent from the following detailed description of the various aspects of the invention taken in conjunction with the accompanying drawings.

### BRIEF DESCRIPTION OF THE DRAWINGS

FIG. 1 depicts synthesis of embodiments of solid imidazolium-based zwitterionic copolymers and their chemical characterization using FTIR. A) shows a scheme of the substrate-independent and conformal iCVD deposition; B) shows deposition conditions used and the film compositions that resulted from those conditions; C) shows FTIR spectra of homopolymer of PVI, copolymers with the VI contents of ˜55 mol %, ˜26 mol %, and ˜17 mol %, and homopolymer of PDVB. The dashed rectangle indicates the characteristic peak of the methyl group in PDVB and the dotted rectangle indicates the characteristic peaks of the C—N bond in the imidazole ring in PVI; D) shows the derivatization reaction, where copolymer films were treated with 1,3-propanesultone for 24 hours; e) FTIR spectra of copolymers treated with a vapor of 1,3-propanesultone at 40° C., 60° C., and 100° C., respectively. The dashed rectangles indicate the characteristic peaks of the SO3- symmetric vibration and the O═S═O asymmetric vibration.

FIG. 2 shows an XPS survey scan of precursor copolymers (CP55, CP26 and CP17) according to certain embodiments of the invention, demonstrating the presence of 0, N, and C elements in the copolymers.

FIGS. 3A and 3B are FTIR spectra of: 3A: copolymer 26 (i.e., CP26 in the main text); and 3B: copolymer 17 (i.e., CP17 in the main text); and those treated by a vapor of 1,3-propanesultone at the derivatization temperatures of 40° C., 60° C., 80° C. and 100° C.

FIG. 4 shows characterization of material surface properties using CA, high-resolution XPS, and AFM. A) shows CA on as deposited and derivatized copolymers, i.e., CP55, CP26 and CP17, where CA for each film was measured at the derivatization temperatures of 40° C., 60° C., and 100° C. The dashed lines indicated the CA values of PVI and PDVB, respectively; B) shows chemical structures of imidazole and the imidazolium-based zwitterionic moieties and their XPS high resolution scans of N(1s) for CP55 and its derivatives; C) shows AFM images of uncoated Si wafer and wafer coated with CP55 or CP55-60.

FIG. 5 shows XPS high-resolution scans of C(1s) of CP55, CP55-40, CP55-60, and CP55-100.

FIG. 6 shows XPS survey scans of CP55-40, CP55-60, CP55-100.

FIG. 7 shows XPS high-resolution scans of S(2p) of CP55-60.

FIG. 8 show images of the static water droplets on P1VI (homopolymer), PDVB (homopolymer), CP55, CP26, and CP17, and those treated by a vapor of 1,3-propanesultone at the derivatization temperatures of 40° C., 60° C., 80° C., and 100° C. respectively.

FIG. 9 shows results demonstrating enhanced deactivation and repulsion of HCoV-OC43 on imidazolium-based zwitterionic polymers. A) shows immunofluorescence imaging of the HCoV-OC43-infected HCT-8 cells taken at 36 hours post-infection on glass, PVC, Cu, and the CP55-60 coating. MOI: 0.05; HCoV-OC43 S. The spike protein in HCoV-OC43 was marked red using primary anti-HCoV-OC43 S antibodies and Alexa Fluor 568 labeled goat anti-rabbit IgG, and cell nuclei were marked as blue using Hoechst 33358; B) shows the percentage of cells infected by HCoV-OC43 that settled on the four surfaces, calculated by analyzing part A) using ImageJ. Data are shown as the mean±SD (n=5); p values were calculated using the student t-test; C) shows the number of attached virus particles on glass, PVC, Cu, and CP55-60 surfaces counted from SEM images of each surface. Data are shown as the mean±SD (n=4); p values were calculated using student t-test. The inset shows a representative SEM image of surface-attached HCoV-OC43.

FIGS. 10A-C show reduced biofilm formation and production of pyoverdine on the CP55-60 surfaces. FIG. 10A shows absorbance measurements of the crystal violet-staining of and FIG. 10B shows SEM images of the biofilms after incubating for 24 hours with uncoated PVC and PVC coated with PDVB, un-derivatized CP55 and the CP55-60. Biofilms on CP55, PDVB, and PVC exhibited greater numbers of bacteria and thick and mature EPS structures, whereas the biofilms on CP55-60 grew to a less degree with sparse EPS. FIG. C shows fluorescence measurements of the production of pyoverdine after a 24-hour incubation with uncoated PVC and those coated with PDVB, un-derivatized CP55, and the CP55-60. The fluorescent emission at 460 nm, representative of pyoverdine, was normalized by the OD₆₀₀ of the culture medium. Data are shown as mean±SD (n=6).

FIGS. 11A-C show demonstration of the substrate-independent nature of the synthesis approach described herein. FIG. 11A shows optical images and the elemental mapping obtained using SEM-EDX, of the pristine and coated 96-well plates, representing curved substrates; FIG. 11B show optical images, SEM images, and SEM-EDX elemental mapping of the pristine and coated glass fiber filter with micron-level 3D structures; FIG. 11C shows optical images, SEM images and SEM-EDX elemental mapping of the pristine and coated polycarbonate membrane filters with 800-nm pores.

### DETAILED DESCRIPTION

In the following and attached description, reference is made to the accompanying drawings and text that form a part hereof, and in which is shown by way of illustration specific embodiments which may be practiced. These embodiments are described in detail to enable those skilled in the art to practice the invention, and it is to be understood that other embodiments may be utilized and that structural, logical, and electrical changes may be made without departing from the scope of the present invention. The following and descriptions of example embodiments are, therefore, not to be taken in a limited sense, and the scope of the present invention is defined by the appended claims.

Hydrocarbon refers to any substituent comprised of hydrogen and carbon as the only elemental constituents. Unless otherwise specified, hydrocarbyl groups may be optionally substituted. An unsubstituted hydrocarbon may be referred to, e.g., as a “pure hydrocarbon”. The term hydrocarbon includes alkyl, cycloalkyl, polycycloalkyl, alkenyl, alkynyl, aryl and combinations thereof. Examples include phenyl, naphthyl, benzyl, phenethyl, cyclohexylmethyl, camphoryl and naphthylethyl. In some embodiments, hydrocarbon groups are aliphatic. In some embodiments, hydrocarbon groups are aromatic. In some embodiments, a hydrocarbon group may have from 1 to 50 carbon atoms therein (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 carbon atoms).

Unless otherwise specified, an “alkyl” group is intended to include linear, branched, or cyclic hydrocarbon structures and combinations thereof. A combination would be, for example, cyclopropylmethyl. Lower alkyl refers to alkyl groups of from 1 to 6 carbon atoms. Examples of lower alkyl groups include methyl, ethyl, propyl, isopropyl, butyl, s- and t-butyl and the like. In some embodiments, alkyl groups are those of C₂₀ or below (i.e., C₁₋₂₀ alkyl). Cycloalkyl is a subset of alkyl and includes cyclic hydrocarbon groups of from 3 to 8 carbon atoms. Examples of cycloalkyl groups include c-propyl, c-butyl, c-pentyl, norbornyl and the like. Unless otherwise specified, an alkyl group may be substituted or unsubstituted.

An “alkenyl” group refers to an unsaturated hydrocarbon group containing at least one carbon-carbon double bond, including straight-chain, branched-chain, and cyclic groups. In some embodiments, an alkenyl group has 1 to 12 carbons (i.e., 1, 2, 3, 4, 5, 6, 7, 8, 9, 10, 11, or 12 carbons). Lower alkenyl designates an alkenyl group of from 1 to 7 carbons (i.e., 1, 2, 3, 4, 5, 6, or 7 carbons). Unless otherwise specified, an alkenyl group may be substituted or unsubstituted.

An “alkynyl” group refers to an unsaturated hydrocarbon group containing at least one carbon-carbon triple bond, including straight-chain, branched chain, and cyclic groups. Preferably, the alkynyl group has 1 to 12 carbons. The alkynyl group may be substituted or unsubstituted.

Aryl and heteroaryl (or aromatic and heteroaromatic moieties, respectively), mean (i) a phenyl group (or benzene) or a monocyclic 5- or 6-membered heteroaromatic ring containing 1-4 heteroatoms selected from oxygen (O), nitrogen (N), phosphorus (P), or sulfur (S); (ii) a bicyclic 9- or 10-membered aromatic or heteroaromatic ring system containing 0-4 heteroatoms selected from O, N, P, or S; or (iii) a tricyclic 13- or 14-membered aromatic or heteroaromatic ring system containing 0-5 heteroatoms selected from O, N, P, or S. The aromatic 6- to 14-membered carbocyclic rings include, e.g., benzene, naphthalene, indane, tetralin, and fluorene and the 5- to 10-membered aromatic heterocyclic rings include, e.g., imidazole, pyridine, indole, thiophene, benzopyranone, thiazole, furan, benzimidazole, quinoline, isoquinoline, quinoxaline, pyrimidine, pyrazine, tetrazole, and pyrazole. As used herein aryl and heteroaryl refer to residues in which one or more rings are aromatic, but not all need be.

The long-term solution needed to reduce fomite transmission requires an antiviral material that, ideally: (i) could be applied in a substrate-independent and conformal manner, (ii) demonstrates efficacy against coronaviruses, (iii) deactivates viruses without the need for incubation with medium (e.g., by demonstrating deactivation of viruses in aerosols, a main medium for fomite-mediated disease spreading), and (iv) remains effective under dry ambient or wetted conditions.

The present invention provides embodiments of an imidazolium-based zwitterionic polymer that satisfies the foregoing criteria and demonstrates anti-coronavirus characteristics in the context of (a) contact-deactivation under dry ambient conditions and (b) adhesion-repelling under wetted conditions.

In a first aspect, the invention provides a solid zwitterionic copolymer comprising repeat units of formulas (I) and (II)

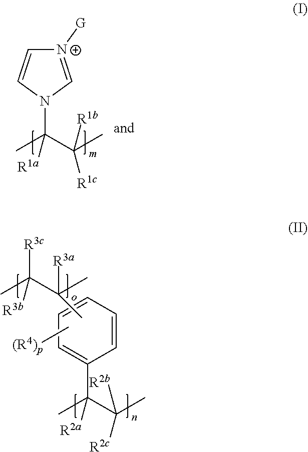

wherein
G is a moiety comprising at least one negatively charged functional group;
R^{1a}, R^{1b}, and R^{1c} are each independently selected from hydrogen, alkyl, phenyl, halo, hydroxyl, amino, nitro, and cyano;
R^{2a}, R^{2b}, and R^{2c} are each independently selected from hydrogen, alkyl, phenyl, halo, hydroxyl, amino, nitro, and cyano;
R^{3a}, R^{3b}, and R^{3c} are each independently selected from hydrogen, alkyl, phenyl, halo, hydroxyl, amino, nitro, and cyano;
R⁴ is in each instance independently selected from alkyl, phenyl, halo, hydroxyl, amino, nitro, and cyano;
m is an integer that is ≥1;
n is an integer that is ≥1;
o is an integer that is ≥1; and
p is an integer that is 0-4.

Embodiments of the inventive copolymer demonstrate anti-viral properties due to the zwitterionic nature of the copolymer and the resultant strong electrostatic interaction with water molecules.

Indeed, embodiments of the inventive solid imidazolium-based zwitterionic polymer possesses antiviral efficacy based on their distinct property that the carbon atom at the C-2 position of imidazolium carries a considerable positive charge. Although the imidazolium-based zwitterionic moiety has a net neutral charge, its electrostatic potential is distributed such that the carbon at the C-2 position of the imidazolium ring carries a considerable positive charge, while the nitrogen and other nearby carbon atoms are slightly negatively charged. As such, the hydrogen bonded to the C-2 carbon in imidazolium exhibits mild acidity, which makes it an excellent hydrogen bond donor, enabling enhanced interactions with amino acids.

While (I) and (II) are referred to herein as repeat units, it will be readily appreciated by persons having ordinary skill in the art that in certain embodiments (e.g., when m is 1, or n and o are 1), then such particular unit in the polymer is a single unit that does not repeat, at least in such instance.

G is a moiety comprising at least one negatively charged functional group. It may be any art-accepted moiety that provides a negative charge. In some embodiments, the at least one negatively charged functional moiety comprises a carboxylate anion, a sulfonate anion, a phosphonate anion, or an oxygen atom. In particular embodiments, G is a structural unit from 1,3-propane sultone (PS).

In some embodiments, G is —(CH₂)₁₋₆SO₃⁻ (e.g., —(CH₂)SO₃⁻, —(CH₂)₂SO₃⁻, —(CH₂)₃SO₃⁻, —(CH₂)₄SO₃⁻, —(CH₂)₅SO₃⁻, or —(CH₂)₆SO₃⁻). In particular embodiments, G is —(CH₂)₁₋₆SO₃⁻.

R^{1a}, R^{1b}, and R^{1c} are each independently selected from hydrogen, alkyl, phenyl, halo (e.g., fluorine, chlorine, bromine, or iodine), hydroxyl, amino, nitro, and cyano. In some embodiments, R^{1a}, R^{1b}, and R^{1c} are each independently selected from hydrogen and C₁₋₁₂alkyl (i.e., C₁, C₂, C₃, C₄, C₅, C₆, C₇, C₈, C₉, C₁₀, C₁₁, or C₁₂ alkyl), including any and all ranges and subranges therein. In particular embodiments, R^{1a}, R^{1b}, and R^{1c} are each independently selected from hydrogen and alkyl (e.g., C₁₋₁₂alkyl, C₁₋₆alkyl, C₁₋₃alkyl, etc.).

R^{2a}, R^{2b}, and R^{2c} are each independently selected from hydrogen, alkyl, phenyl, halo (e.g., fluorine, chlorine, bromine, or iodine), hydroxyl, amino, nitro, and cyano. In some embodiments, R^{2a}, R^{2b}, and R^{2c} are each independently selected from hydrogen and C₁₋₁₂alkyl (i.e., C₁, C₂, C₃, C₄, C₅, C₆, C₇, C₈, C₉, C₁₀, C₁₁, or C₁₂ alkyl), including any and all ranges and subranges therein. In particular embodiments, R^{1a}, R^{2b}, and R^{2c} are each independently selected from hydrogen and alkyl (e.g., C₁₋₁₂alkyl, C₁₋₆alkyl, C₁₋₃alkyl, etc.).

R^{3a}, R^{3b}, and R^{3c} are each independently selected from hydrogen, alkyl, phenyl, halo (e.g., fluorine, chlorine, bromine, or iodine), hydroxyl, amino, nitro, and cyano. In some embodiments, R^{3a}, R^{3b}, and R^{3c} are each independently selected from hydrogen and C₁₋₁₂alkyl (i.e., C₁, C₂, C₃, C₄, C₅, C₆, C₇, C₈, C₉, C₁₀, C₁₁, or C₁₂ alkyl), including any and all ranges and subranges therein. In particular embodiments, R^{3a}, R^{3b}, and R^{3c} are each independently selected from hydrogen and alkyl (e.g., C₁₋₁₂alkyl, C₁₋₆alkyl, C₁₋₃alkyl, etc.).

R⁴ is in each instance independently selected from alkyl, phenyl, halo (e.g., fluorine, chlorine, bromine, or iodine), hydroxyl, amino, nitro, and cyano. In some embodiments, R⁴ is in each instance independently selected from halo and C₁₋₁₂alkyl (i.e., C₁, C₂, C₃, C₄, C₅, C₆, C₇, C₈, C₉, C₁₀, C₁₁, or C₁₂ alkyl), including any and all ranges and subranges therein. In particular embodiments R⁴ is in each instance independently selected from fluorine, chlorine, bromine, and alkyl (e.g., C₁₋₁₂alkyl, C₁₋₆alkyl, C₁₋₃alkyl, etc.).

In embodiments of the invention, p is an integer that is 0-4 (i.e., p is 0, 1, 2, 3, or 4). In particular embodiments, p is 0 or 1 (e.g., 0)

In some embodiments, m, n, and o are integers independently selected from 1 to 10,000 (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, 9100, 9200, 9300, 9400, 9500, 9600, 9700, 9800, 9900, or 10000), including any and all ranges and subranges therein. In some embodiments, n and o are the same integer.

In some embodiments, the copolymer includes one or more structural unit(s) from one or more additional monomer(s).

In some embodiments, the copolymer comprises a repeat unit from a crosslinking moiety X. It is envisaged that the copolymer may comprise any art-accepted crosslinking moiety X. According to particular embodiments, X is selected from a unit of polymerized monomer selected from arylene, alkylene, phenylene, 1,4-phenylene, ethylene glycol dimethacrylate, ethylene glycol diacrylate, vinyl methacrylate, allyl methacrylate, maleic anhydride, 1,3,5-trivinyltrimethlcyclotrisiloxane glycidyl methacrylate, and di(ethylene glycol) divinyl ether, or any combination thereof.

In some embodiments, the sum of repeat units (I) and (II) in the inventive copolymer makes up 20 to 100 mol % (e.g., 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, or 100 mol %) of all units present in the copolymer. As will be apparent, where (I) and (II) make up 100 mol % of the copolymer, no other structural units from other monomers will be present.

In some embodiments, the repeat unit (I) makes up 5 to 95 molar % (mol %) of the copolymer (e.g., 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 mol %), including any and all ranges and subranges therein, of units in the copolymer (e.g., 10 to 75 mol %).

In some embodiments, the repeat unit (II) in the copolymer makes up 5 to 95 mol % of the copolymer (e.g., 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 mol %), including any and all ranges and subranges therein, of units in the copolymer (e.g., 25 to 90 mol %).

In some embodiments, the copolymer comprises one or more repeat units having the formula (III)

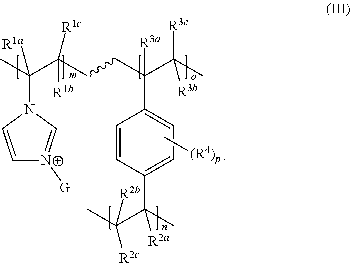

In some embodiments, the copolymer comprises one or more repeat units having the formula (III′).

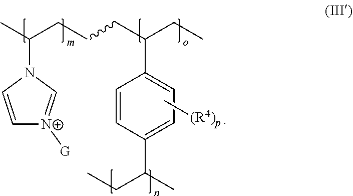

In some embodiments, the copolymer comprises one or more repeat units having the formula (III″):

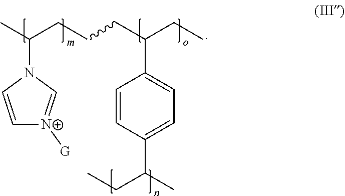

In some embodiments, the copolymer comprises one or more repeat units having the formula (III′″)

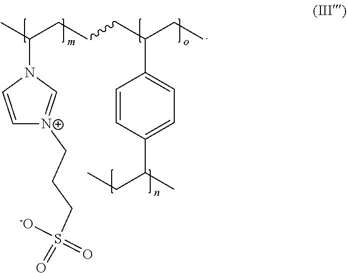

In some embodiments, excluding the composition of G, the copolymer has an elemental composition having 0 to 30 molar % oxygen (i.e., 0.0, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 mol %), including any and all ranges and subranges therein (e.g., 5-30 mol %, 10-30 mol %, etc.).

As used herein, “elemental composition” refers to the elements present in a specified polymer or portion thereof. For the sake of simplicity, hydrogen is not considered when determining the elemental composition of a polymer.

In some embodiments, excluding the composition of G, the copolymer has an elemental composition characterized by the following atomic ratios (molar %'s):
Carbon: 55 to 85% (e.g., 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, or 85%), including any and all ranges and subranges therein (e.g., 60 to 82%, 65 to 82%, etc.);
Nitrogen: 2 to 16% (e.g., 1, 2, 3, 4, 5, 6, 7, 8, 9, 10, 11, 12, 13, 14, 15, or 16%), including any and all ranges and subranges therein (e.g., 3 to 15%, 3 to 13%, etc.); and
Oxygen: 0 to 30% (e.g., 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30%), including any and all ranges and subranges therein (e.g., 5 to 30%, 10 to 30%, etc.).

In some embodiments, excluding the composition of G, the copolymer has an elemental composition having:
13 to 250 oxygen;
3 to 16% nitrogen; and
60 to 82% carbon.

In some embodiments, the copolymer is produced by an all-dry technique. Such techniques exclude use of solvent during copolymer production.

In some embodiments of the inventive copolymer, units of formulas (I′) and (II) are incorporated into an intermediate of the copolymer (e.g., the copolymer prior to derivatization adding G) via all all-dry technique, such as initiated chemical vapor deposition (iCVD)

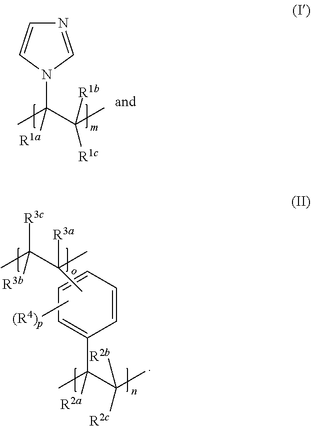

In some embodiments, units of formulas (I′) and (II) are incorporated into an intermediate of the copolymer via an all-dry technique, such as initiated chemical vapor deposition (iCVD):

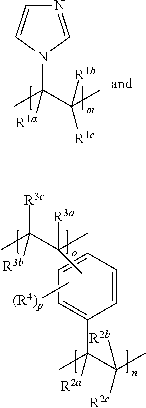

In some embodiments, the copolymer has a water contact angle (CA) of less than 10°.

In some embodiments, the copolymer is a polymer that can be applied to curved substrates as a coating with uniform thickness. As used herein, “uniform thickness” means the same thickness, plus or minus 10% (e.g., ±10, 9, 8, 7, 6, 5, 4, 3, 2, 1, 0.9, 0.8, 0.7, 0.6, 0.5, 0.4, 0.3, 0.2, or 0.1%).

In some embodiments, the inventive copolymer has an indentation modulus for mechanical properties of approximately 5-9 GPa (e.g., 5.0, 5.1, 5.2, 5.3, 5.4, 5.5, 5.6, 5.7, 5.8, 5.9, 6.0, 6.1, 6.2, 6.3, 6.4, 6, 5, 66, 67, 68, 69, 7.0, 7.1, 7.2, 7, 3, 7.4, 7.5, 7.6, 7.7, 7.8, 7.9, 8.0, 8.1, 8.2, 8.3, 8.4, 8.5, 8.6, 8.7, 8.8, 8.9, or 9.0 GPa), including any and all ranges and subranges therein (e.g., 6.5-7.5 GPa, or about 7 GPa).

In some embodiments, the copolymer is hydrophilic.

In some embodiments, the copolymer is insoluble in water, tetrahydrofuran (THF), dimethyl sulfoxide (DMSO), and dimethylformamide (DMF), due to its highly crosslinking properties.

In some embodiments, the copolymer is substantially insoluble in water, THF, DMSO, and DMF, due to its highly crosslinking properties. As used herein, “substantially insoluble” means the copolymer has a solubility in an indicated solvent at 20° C. of 0.1 grams per liter or less.

In some embodiments, the copolymer presents a Fourier transform infrared (FTIR) spectrum comprising one or more peaks as described in this specification and in the accompanying drawings, all peak values being +/−8 cm⁻¹.

In a second aspect, the invention provides a composition comprising the copolymer according to the first aspect of the invention, including any embodiment or combination of embodiments thereof.

In some embodiments, the composition is a film.

In some embodiments, the composition is a film comprising a layer of the copolymer according to the first aspect of the invention.

In some embodiments, the layer of the copolymer has a thickness of 5 nm to 100 microns (e.g., 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 1000, 2000, 3000, 4000, 5000, 6000, 7000, 8000, 9000, 10000, 11000, 12000, 13000, 14000, 15000, 16000, 17000, 18000, 19000, 20000, 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000, 45000, 46000, 47000, 48000, 49000, 50000, 51000, 52000, 53000, 54000, 55000, 56000, 57000, 58000, 59000, 60000, 61000, 62000, 63000, 64000, 65000, 66000, 67000, 68000, 69000, 70000, 71000, 72000, 73000, 74000, 75000, 76000, 77000, 78000, 79000, 80000, 81000, 82000, 83000, 84000, 85000, 86000, 87000, 88000, 89000, 90000, 91000, 92000, 93000, 94000, 95000, 96000, 97000, 98000, 99000, or 100000 nm), including any and all ranges and subranges therein.

In some embodiments, the film is a conformal film. As used herein, the terms “conformal” and “conformally”, refer to a layer that adheres to and uniformly covers exposed substrate with a thickness having a variation of less than 10% (e.g., less than 10, 9, 8, 7, 6, 5, 4, 3, 2, 1, 0.9, 0.8, 0.7, 0.6, 0.5, 0.4, 0.3, 0.2, or 0.1%) relative to the average thickness of the film.

In some embodiments, the invention provides a composition comprising: a coating material comprising a copolymer according to the first aspect of the invention; and a substrate; wherein the substrate is coated (e.g., conformally coated) with a layer of the coating material (e.g., the 5 nm to 100 μm layer discussed above) on at least one side.

The substrate may be any desirable art-accepted substrate. In some embodiments, the substrate is selected from porous material, non-porous material, organic material (e.g. plastic, fabric, paper products, wood), and inorganic material (e.g. metal, glass, ceramics, or porcelain).

In some embodiments, the film has a water contact angle (CA) of less than 10°.

In some embodiments, the composition comprises: a coating material comprising an embodiment of the inventive copolymer, and a substrate: wherein the substrate is coated with a layer of the coating material on at least one side.

In some embodiments, a film of the inventive copolymer has a root-mean-square (RMS) roughness of less than 1 nm (e.g., less than 1, 0.9, 0.8, 0.7, or 0.6 nm).

In a third aspect, the invention provides an article comprising the copolymer according to the first aspect of the invention or the composition according to the second aspect of the invention.

The article may be any art-acceptable article.

In some embodiments, the article is one for which there is a desire to include a conformal polymer coating. In particular embodiments, the article is one for which there is a desire to prevent or reduce viral adhesion and/or proliferation. In some embodiments the article includes one or more curved surfaces, which are conformally coated with a film of the inventive copolymer.

In a fourth aspect, the invention provides a method of making the copolymer according to the first aspect of the invention (or the composition according to the second aspect of the invention, or the article according to the third aspect of the invention), said method comprising:
placing a substrate in an iCVD reactor under vacuum condition;
flowing into the reactor in parallel or in sequence a plurality of materials comprising.
   an inert carrier gas;
   an initiator;
   a first monomer that is the source of the imidazole moiety in the formula (I) repeat units; and
   a second monomer that is the source of the formula (II) repeat units:
      thereby forming a polymer on the substrate via iCVD; and
      exposing the polymer to a negatively charged functional moiety, thereby forming the copolymer.

In some embodiments, said exposing the polymer to a negatively charged functional moiety comprises exposing the polymer layer to a vapor of 1,3-propanesultone.

In a fifth aspect, the invention provides a method of.
protecting a substrate from viral contamination; or
decreasing, reducing, or inhibiting viral proliferation on a substrate, or
deactivating a virus on a substrate;
   said method comprising applying a layer of the copolymer according to the first aspect of the invention on a substrate.

In some embodiments, applying the layer of the copolymer on the substrate comprises:
placing the substrate in an iCVD reactor under vacuum condition;
flowing into the reactor in parallel or in sequence a plurality of materials comprising
   an inert carrier gas;
   an initiator;
   a first monomer that is the source of the imidazole moiety in the formula (I) repeat units; and
   a second monomer that is the source of the formula (II) repeat units;
      thereby forming a polymeric layer on at least one side of the substrate via iCVD; and
      exposing the polymeric layer to a negatively charged functional moiety, thereby forming the layer of the copolymer on the substrate.

In some embodiments, said exposing the polymeric layer to a negatively charged functional moiety comprises exposing the polymer layer to a vapor of 1,3-propanesultone (PS).

In some embodiments of the inventive method, said exposing the polymeric layer to a negatively charged functional moiety results in functionalizing the imidazole ring in the repeat unit (1) with the negatively charged functional moiety G.

In some embodiments, said exposing the polymeric layer to a negatively charged functional moiety comprises exposing the polymeric layer to a compound capable of functionalizing the imidazole in the repeat unit (I) with a moiety comprising a carboxylate anion, a sulfonate anion, phosphonate anion, or an oxygen atom.

### Examples

The invention will now be illustrated, but not limited, by reference to the specific embodiments described in the following examples.

Synthesis of the Precursor Copolymers Via iCVD

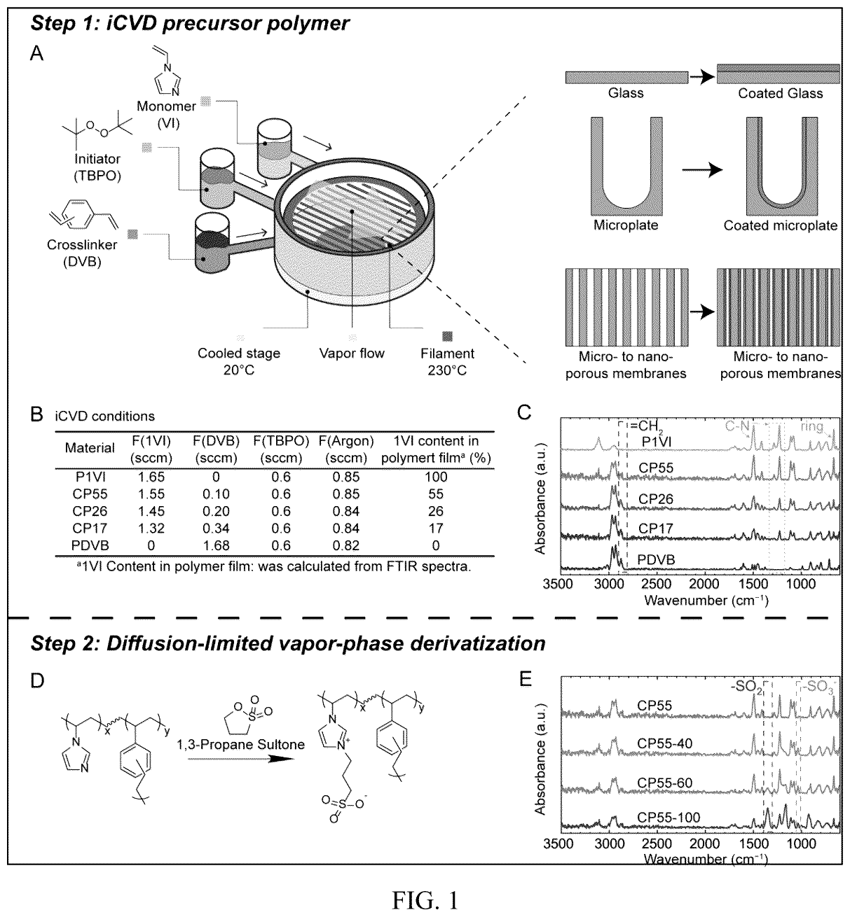

Solid imidazolium-based zwitterionic copolymers were synthesized via a two-step vapor treatment (see FIG. 1). As described below, in the first step, iCVD deposition of vinyl imidazole (VI, monomer) and divinylbenzene (DVB, crosslinker) was performed. The coating of copolymers was subsequently treated using a vapor of 1,3-propanesultone in a second step to obtain the imidazolium-based zwitterionic copolymers. The copolymers were named according to their VI compositions. For example, a copolymer containing 55% VI and 45% DVB according to FTIR-based calculation was labeled as “CP55”.

The crosslinker, DVB, was included because the strong hydration of zwitterionic polymers often renders them soluble in aqueous environments. Introduction of DVB enabled durable coatings on a diverse range of substrates, which has been shown to reduce polymer solubility and enhance the mechanical strength of iCVD polymer coatings. The iCVD technique allows facile incorporation of crosslinkers due to its all-dry nature, using which, films that are insoluble and ultradurable have been obtained.

Initiated chemical vapor deposition (iCVD). Polymer materials were created using iCVD technology in a custom-built cylindrical vacuum reactor (Sharon Vacuum Co Inc., Brockton, MA, USA). Thermal excitation of the initiators was provided by heating a 0.5 mm nickel/chromium filament (80% Ni/20% Cr, Goodfellow) mounted as a parallel filament array. Filament temperature was controlled by a feedback loop, whose reading came from a thermocouple attached to one of the filaments. The filament holder straddled the deposition stage that was kept at desired substrate temperatures using a chiller. The vertical distance between the filament array and the stage was ˜2 cm. Depositions were performed on various substrates: Si wafers (P/Boron<100>, Purewafer), 96-well microplates (2797, Corning), glass slides (Thermo Fisher Scientific), petri dish (Thermo Fisher Scientific), Copper foil (MTI), PVC sheets (McMASTER-CARR), glass fiber filter and polycarbonate membrane filters (Sigma-Aldrich). Cooling of the microplates was further enhanced by a custom-designed aluminum holder. Initiator (tert-butyl peroxide (TBPO, Sigma-Aldrich, 98%)) and monomers (1-vinylimidazole (VI, Sigma-Aldrich, 99%) Divinylbenzene (DVB, Sigma-Aldrich, 80%)) were used without further purification. During the iCVD depositions, TBPO and argon patch flow were fed to the reactor at room temperature through mass flow controllers at 1.0 sccm and desired flow rates, respectively. VI was heated to 70° C. in glass ajar to create sufficient pressure to drive vapor flow. PVI-co-DVB films were deposited at a filament temperature of 230° C. The total pressure of the chamber was controlled by a butterfly valve. In situ interferometry with a HeNe laser source (wavelength=633 nm, JDS Uniphase) was used to monitor the film growth on a Si substrate.

Derivatization. The coated substrates were fixed in a crystallizing dish (VWR) with 1 g of 1,3-propanesultone (Sigma-Aldrich, 98%). The crystallizing dish was placed inside a vacuum oven that was maintained at desired temperature for 24 hours to allow the 1,3-propanesultone vapor to react with the PVI-co-DVB coating.

Polymer film characterization. Fourier transform infrared (FTIR) measurements were performed on a Bruker Vertex V80v vacuum FTIR system in transmission mode. A deuterated triglycine sulfate (DTGS) KBr detector over the range of 400-4000 cm¹ was adopted with a resolution of 4 cm. The measurements were averaged over 64 scans to obtain a sufficient signal-to noise ratio. All the spectra were baseline corrected by subtracting a background spectrum of Si.

During XPS, samples were analyzed using a Surface Science Instruments SSX-100 ESCA Spectrometer with operating pressure ca. 1×10⁻⁹ Torr. Monochromatic Al Kα x rays (1486.6 eV) with photoelectrons collected from a 800-μm-diameter area. Photoelectrons were collected at a 550 emission angle with source to analyzer angle of 70°. A hemispherical analyzer determined electron kinetic energy, using a pass energy of 150 eV for wide/survey scans, and 50 eV for high resolution scans. A flood gun was used for charge neutralization of non-conductive samples. Data analysis was conducted by CasaXPS with Shirley as the background. All the samples were stored under vacuum at room temperature for a week before XPS analysis. For the depth profiling of the imidazolium versus imidazole contents, the thin films of CP55-60, deposited on a Si wafer cut into pieces, were etched using ion milling. The etching depths of 20, 40, 60, 100 nm, respectively, were samples using XPS survey scans. The contents of imidazolium and imidazole groups were calculated by analyzing the content of sulfur atomic ratio. The content of unreacted imidazole was calculated as complementary to the content of imidazolium.

Contact angle measurements were performed using a Rame-Hart Model 500 goniometer equipped with an automated water dispenser. Static contact angle measurements were recorded using a 2 μL droplet dispensed upon silicon wafers coated with the polymer thin films.

Surface roughness and topography was measured using an Asylum Research MFP-3D-BIO AFM Scans were recorded across 2.5×2.5 μm regions at 1.0 Hz in AC-air tapping mode.

SEM images and elemental maps were obtained using Zeiss Gemini 500 with an acceleration voltage of 10 kV. Gold was sputter coated onto all samples prior to imaging.

### Optimization of the Composition of the Copolymers

The compositions of the copolymer films were systematically varied to simultaneously optimize (i) the antiviral/antibacterial performance, which calls for a greater VI content, and (ii) film durability, which calls for a greater DVB content. The copolymer composition was controlled by adjusting the flowrates of VI and DVB (FIG. 1), which in turn determined a key synthesis parameter, P^{m}/P^{sat}, i.e., the ratio of partial pressure of a monomer to its saturation pressure at the temperature of the stage. P^{m}/P^{sat} indicates the concentration of a monomer on the substrate surface (i.e., where the polymerization occurs) based on the Brunauer-Emmett-Teller (BET) isotherm. The sum of the P^{m}/P^{sat} values for VI and DVB was held constant at ˜0.5 for all depositions to maintain a deposition rate of ˜5 nm˜min and to prevent condensation of the monomers (which could cause defects in the film). Furthermore, a patch flow of Argon was used to keep the total gas flow rate constant, ensuring unchanged residence time inside the iCVD reactor during different deposition runs.

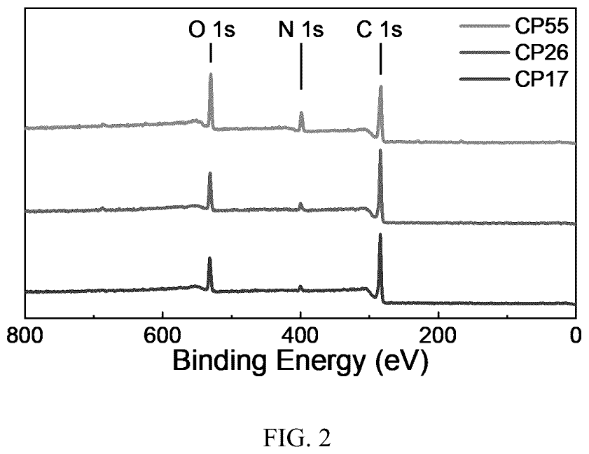

Successful polymerization of VI and DVB was confirmed, and composition of the copolymer films were quantified using X-ray photoelectron spectroscopy (XPS) and Fourier transform infrared spectroscopy (FTIR) A XPS survey scan (see FIG. 2) confirmed the elemental composition of O, N, and C in the deposited polymer films, as summarized in Table I below.

TABLE I
Elemental Compositions of CP55, CP26, CP17

| Materials | C % (% StDev)^{a} | N % (% StDev)^{a} | O % (% StDev)^{a} |
|---|---|---|---|
| CP55 | 67.1 (0.4) | 11.8 (0.3) | 21.1 (0.3) |
| CP26 | 79.0 (0.4) | 4.8 (0.4) | 16.2 (0.3) |
| CP17 | 81.1 (0.4) | 3.1 (0.3) | 15.8 (0.3) |

^{a}StDev represents the standard deviation.

Appreciable oxygen concentrations were detected in the XPS survey scans, which were attributed to adventitious organic matters and the initiator radical, tert-butoxide. At the filament temperature employed (i.e., 230° C.), tert-butoxide is considered the dominating initiation species. Furthermore, the incorporation of oxygen from tert-butoxide was likely further enhanced due to its role as a terminating species given the low reactivity of VI. The FTIR spectra of poly(1-vinylimidazole) (PVI), poly(divinylbenzene) (PDVB) and copolymer films confirmed their chemical structure (see FIG. 1, section C). The absorption band at 3105 cm⁻¹, 1512 cm⁻¹ and 664 cm⁻¹, attributed to the stretching vibration of C—H, C═N and vibration of the imidazole ring respectively, indicated the successful incorporation of VI into the polymer films. The adsorption of 2871 cm⁻¹ came from unreacted vinyl bonds in the DVB, implying the presence of DVB units. The two peaks at 1228 cm⁻¹ and 1284 cm⁻¹, which are characteristic of the aromatic carbon-nitrogen bond in VI, and the peak at 2871 cm⁻¹ of DVB were used to calculate the content of VI unit in the copolymers because they do not overlap with other peaks and show strong adsorption.

Using the Beer-Lambert equation and assuming that the bond oscillator strength is the same for all polymers synthesized here, the area-under-the-peak for the double absorption at 1228 cm⁻¹ and 1284 cm⁻¹ (imidazole ring), and that for the absorption at 2871 cm⁻¹ (unreacted vinyl groups in DVB) were used to calculate the concentrations of VI and DVB respectively in the copolymers. The results are summarized in part B of FIG. 1. The VI content in the copolymers ranged between 17% to 55% due to low reactivity of VI. The high degrees of crosslinking in these thin films are considered to improve the mechanical strength and thus durability. The elemental compositions calculated using the XPS survey scans are shown above in Table I, which demonstrated contents of VI that were slightly lower than those calculated using FTIR. FTIR was selected as the basis of composition analyses due to the known sensitivity of XPS results to the dynamic surface chain reorientation and contamination.

### Derivatization of the Copolymers to Obtain the Zwitterionic Moieties

Following their synthesis via iCVD, the copolymer films were treated with a vapor of 1,3-propanesultone for 24 hours to convert the imidazole group to an imidazolium-based zwitterionic moiety. Temperature of that derivatization reaction was varied to strike a balance between high conversion rate, which is obtained at higher temperatures, and benign reaction conditions to ensure the applicability of this approach to a broad range of substrates, some which may have limited thermostability. For example, the softening point (e.g., those determined by the heat deflection test) for common medical plastics, such as polyvinylchloride (PVC) or polystyrene, is ˜70° C.

A series of derivatization reactions were performed on the copolymer obtained in Step 1 with the greatest VI content, i.e., CP55, to maximize the achievable composition of zwitterionic moieties and thus antimicrobial efficacy Derivatization temperatures of 40° C., 60° C., and 100° C. were used, and 100° C. was included as a control group where complete conversion was anticipated. To reflect the different derivatization temperatures, the treated copolymer samples were denoted with their VI content followed by the derivatization temperature. For example, a copolymer containing 55% VI and 45% DVB, and derivatized at 40° C. was labeled as “CP 55-40” hereinafter.

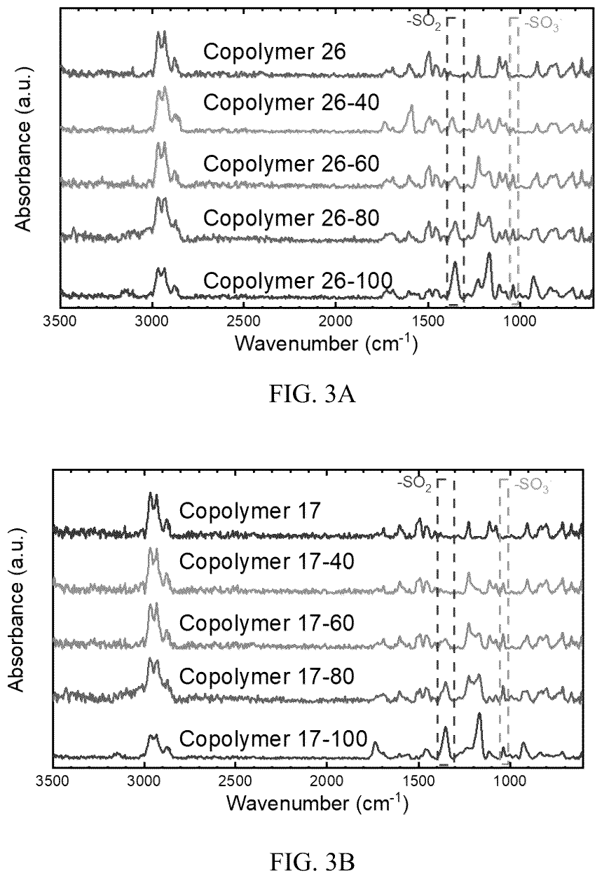

The successful obtainment of imidazolium-based zwitterionic polymer was confirmed using FTIR spectrum (see FIG. 1, part E) The new peak at 1037 cm r was ascribed to the symmetric stretching of the SO₃⁻ group (FIG. 1D), indicating the formation of zwitterionic structure. To capture the concentration of the zwitterionic moieties in the whole film, the peak at 1352 cm⁻¹, characteristic of the antisymmetric stretching of O═S═O, and the peak at 664 cm⁻¹, representing the unreacted imidazole ring, were compared. With the increasing derivatization temperature, FTIR spectra of the treated samples presented a more pronounced peak at 1352 cm⁻¹ and a diminishing peak at 664 cm⁻¹, indicating an increasing concentration of zwitterionic moieties in the polymer film (see FIG. 1, part E and FIGS. 3A-B). The surface concentration of the zwitterionic groups is the most crucial for the antimicrobial efficacy of the polymer coatings, which was characterized in detail using high-resolution XPS.

Surface-Concentrated Zwitterionic Moieties Obtained by the all-Dry Synthesis Approach

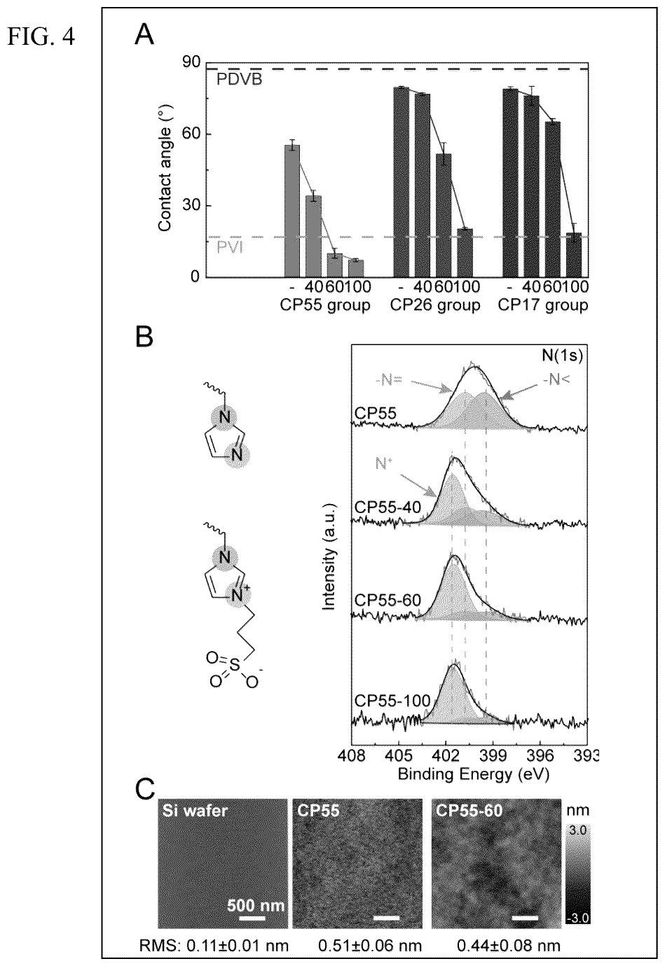

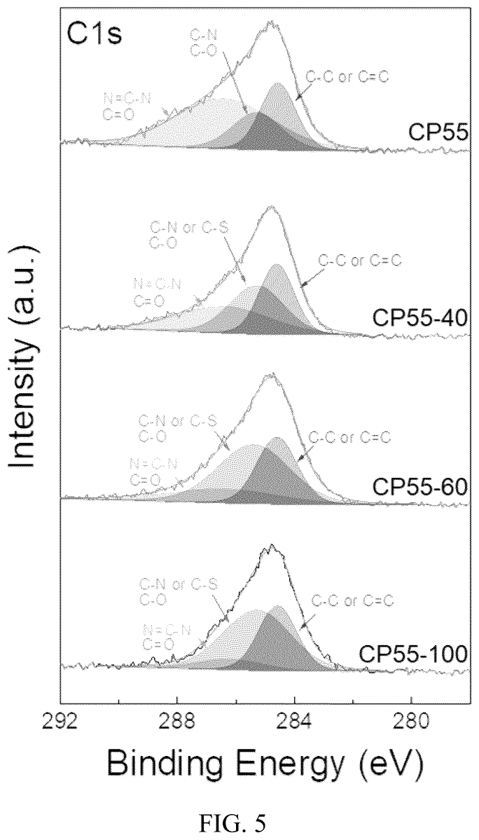

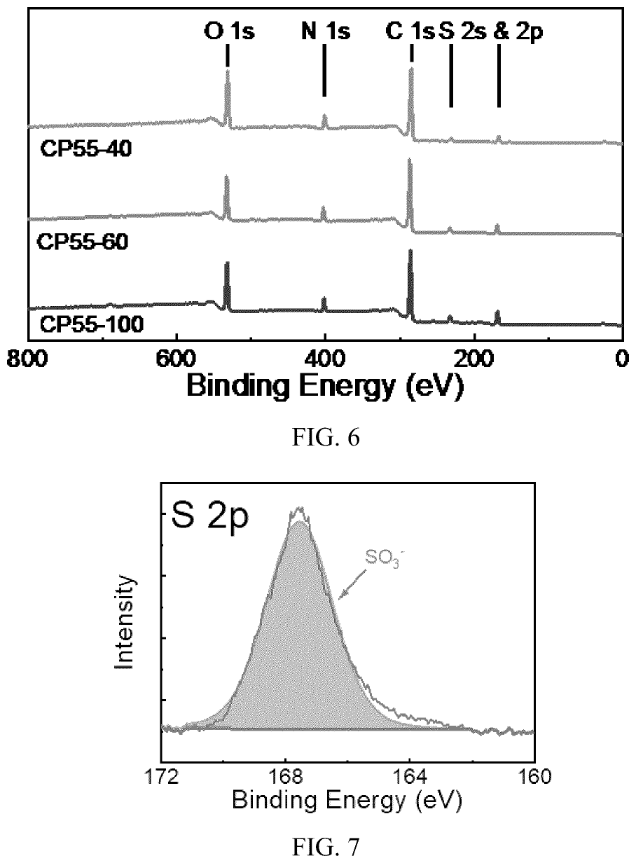

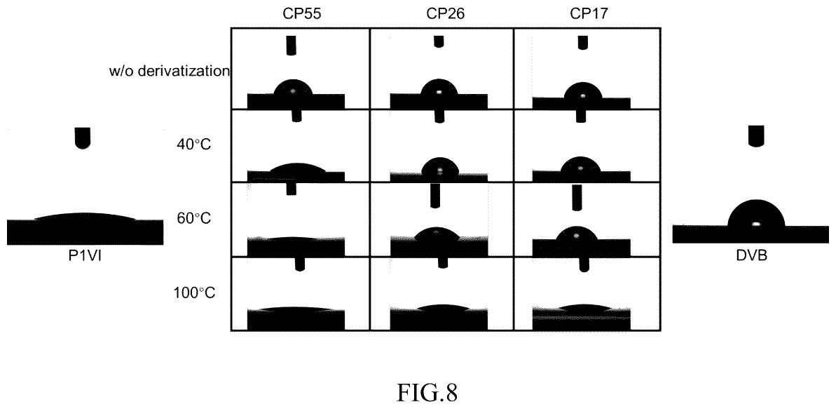

To investigate the surface concentrations of the imidazolium-based zwitterionic moieties in the derivatized films, XPS survey scan and high-resolution scans on the N(1s), C(1s) and S(2p) were performed (FIG. 2, part B, FIGS. 5-7) The peak at 401.5 eV corresponded to the N(1s) in the imidazolium ring (N⁺ in FIG. 4, Part B), whereas the peaks at 399.5 eV and 400.6 eV corresponded to the two unreacted nitrogen atoms in PVI (—N<on the right, and —N═ on the left, FIG. 4). While increasing the derivatization temperature from 40° C. to 60° C. led to a mild increase in the conversion rate, from 51.5% to 70.2%, further increasing it to 100° C. did not yield further increase in the rate of conversion (78.9%) (FIG. 4. Part B). The C(1s) and S(2p) high-resolution scans further confirmed this composition of the film surfaces. The convoluted carbon signals shown in FIG. 5 were attributed to the three classes of chemical environments (i.e., the carbon between the two nitrogen atoms in the imidazole ring, the carbon next to the nitrogen or sulfur, or the carbon surrounded by carbon), the compositions of which were consistent with the results from the N(1s) scans. The S(2p) high-resolution scan confirmed the SO₃⁻ moiety. As such, the derivatization temperature of 60° C. was chosen for subsequent experiments due to the high rate of conversion achieved at this temperature while remaining below the common softening point discussed above.

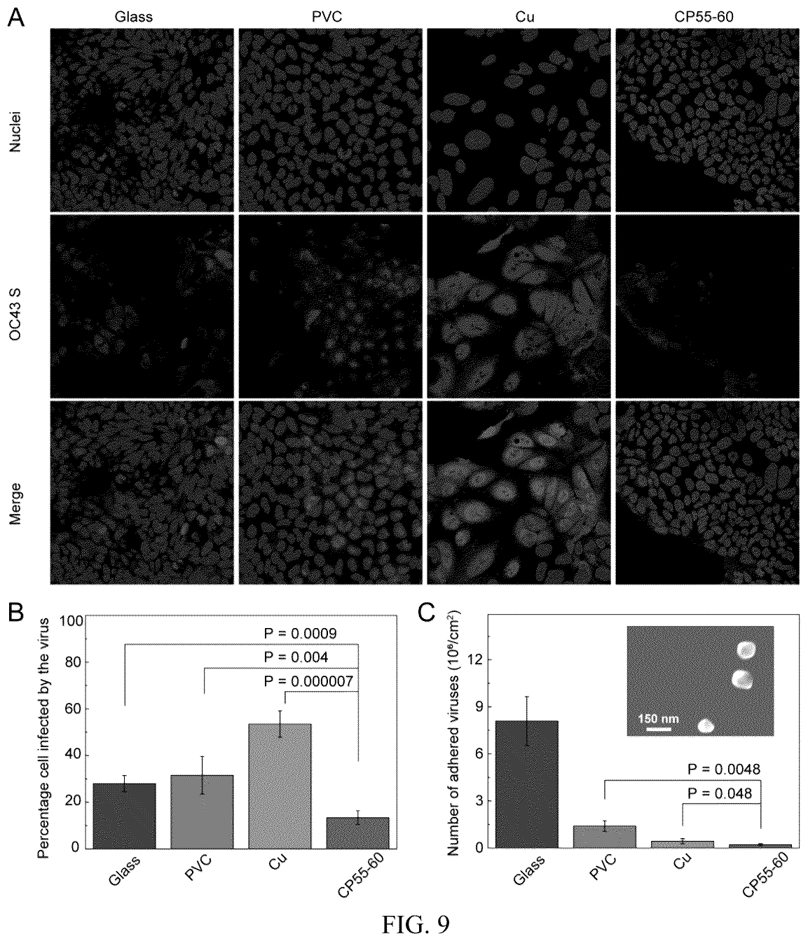

Water contact angle (CA) was also measured on the treated films to characterize their macroscopic hydrophilicity, which reflected the rate of conversion of the derivatization step and was correlated with the potential enthalpic penalty for foulant adhesion and thereby antifouling performance (FIG. 4, Part A). The CA of PVI and PDVB were 16.9+1.2° and 87.3±0.3°, respectively. After copolymerization of the two components, CP55 presented a CA of 55.3±2.3°, and, due to the high DVB content in CP26 and CP17, their CA values were 79 5±0.5° and 78.9±0.9°, respectively, approaching the CA of PDVB (FIG. 4, Part A). The static CA images obtained during those measurements are shown in FIG. 8. The films treated with the vapor of 1,3-propanesultone demonstrated greatly reduced water CA values. With the increasing derivatization temperatures, the CA generally decreased for all three precursor polymers. Among these surfaces, CP55-60 and CP55-100 exhibited super-hydrophilic properties (i.e., CA values below 10°), with the CA values of 9.9±2.1° and 7.5+0.7° for CP55-60 and CP55-100, respectively, despite having a DVB content of as high as 45%. That super-hydrophilicity was attributed to the surface-concentrated zwitterionic moiety, demonstrated using high-resolution XPS. Indeed, the diffusion-limited derivatization spontaneously created a concentration gradient from the coating surface to the bulk film, with the highest conversion achieved at the topmost surface, demonstrated by the depth profiling of imidazolium and imidazole contents (not pictured).

Testing further demonstrated that the iCVD coatings reserved the morphology of the underlying substrates, i.e., the surface roughness captured using atomic force microscope (AFM) remained unchanged before and after the iCVD process and the derivatization (FIG. 4, Part C). Compared to the surface roughness of uncoated Si wafers (0.11±0.01 nm root-mean-square (RMS) roughness), the Si wafers coated with CP55, and CP55-60 exhibited RMS roughness values of 0.51±0 06 nm and 0.44±0 08 nm, respectively. The exceptional smoothness also ensured minimum exposure of available binding sites for virus or bacteria to attach.

### Deactivation of Human Coronavirus HCoV-OC43 Via Contacting the Imidazolium-Based Zwitterionic Polymer

The antiviral activities of the novel imidazole-based zwitterionic copolymer were measured using HCoV-OC43, a human Betacoronavirus that belongs to the same genus as SARS-CoV-2 yet with lower lethality. In order to benchmark the antiviral activities, the repulsion and deactivation efficacies of imidazolium-based zwitterionic polymers were compared against those of glass, PVC, and Cu, representing a range of inorganic, plastic, and metal surfaces commonly employed in public, healthcare, and manufacturing facilities. The antiviral activities of those surfaces were characterized using two approaches to capture (i) deactivation of viruses under dry ambient conditions, as discussed below and (ii) repulsion of viruses under submerged aqueous conditions, which is discussed in the next section.

Virus deactivation was assessed using a process developed to mimic the drying of virus-containing fluids on a surface under dry ambient conditions. A suspension of the HCoV-OC43 virus (10 μL, cultured by following an established protocol using HCT-8 as the host cell was applied onto the aforementioned surfaces [i.e., glass, PVC, Cu, and the coating CP55-60 (applied on a glass slides)], which were allowed to air-dry at lab ambience for around 30 minutes. Once no visible liquid was confirmed, the surfaces were subsequently incubated at 34° C. under 50% relative humidity for 24 hours, by the end of which, viruses were collected via vigorous washing by PBS and assessed for their infectivity. The HCT-8 cells were used again as host cells in the infectivity assay. The HCoV-OC43 suspended in PBS solution was inoculated to HCT-8 cells at a multiplicity of infection (MOI) of 0.05, then the virus culture was quantified at 36 hours post infection. Subsequently, the HCT-8 and HCoV-OC43 were stained by Hoechst 33358 and primary anti-HCoV-OC43 S antibodies and Alexa Fluor 568 labeled goat anti-rabbit IgG, respectively, for imaging.

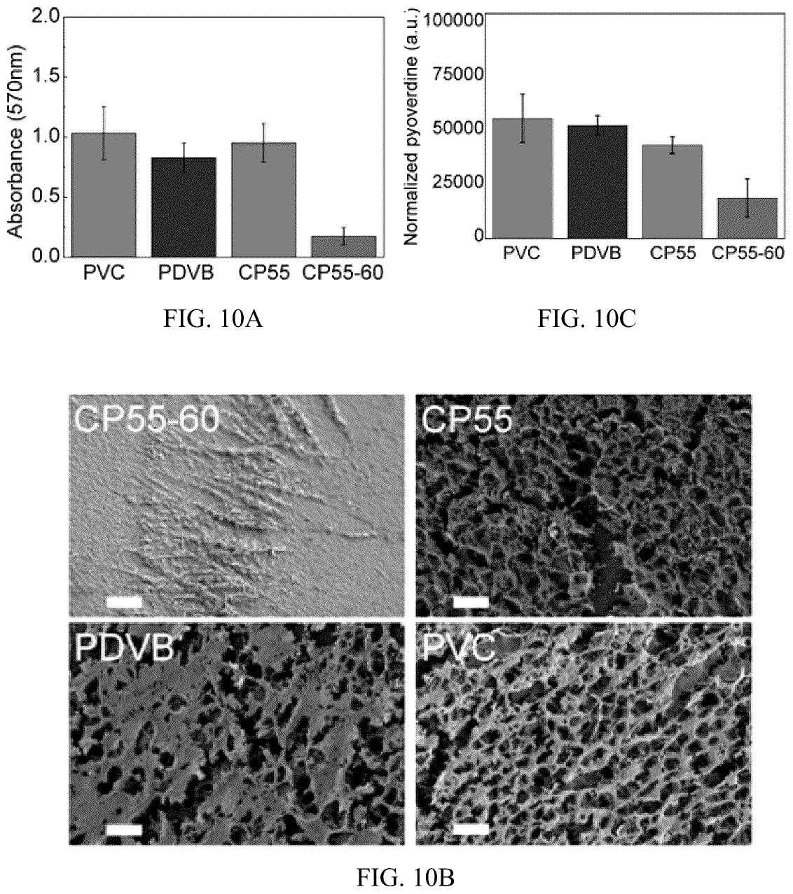

As shown in FIG. 9, Part 3, different colors (not shown in drawings, but depicted in Chen et al., “An imidazolium-based zwitterionic polymer for antiviral and antibacterial dual functional coatings”, Sci. Adv. 8 (2022)) were applied to distinguish between HCT-8 and HCoV-OC43, where the nuclei are shown in blue, and the stained virus is shown in red. The presence of a large number of virus particles around a particular cell nucleus, shown as a bright red area around the blue area, indicates that the cell is infected while the virus is proliferating in the cell. Such cell is marked as infected cell. The infectivity of the inoculated virus can be indirectly known by the statistics of the percentage cell infected by virus.

As shown in FIG. 9, Part B, the lowest infectivity (i.e., the ratio of the infected cells to the total cells) of 13.4% was achieved for CP55-60 surfaces among the four surfaces whereas, under the same conditions, viruses on glass, PVC, and Cu surfaces presented infectivity of 28.0%, 31.5% and 51.5%, respectively That capability of CP55-60 to deactivate coronaviruses under dry ambient conditions was attributed to a variety of molecular interactions between the imidazolium-based zwitterionic polymer and aromatic-rich amino acids through cation-π interactions or polar interactions, leading to denaturation of proteins (i.e., the spike glycoprotein lining the surface of SARS-CoV-2) upon contacting zwitterionic moieties. Such interaction is theoretically stronger for imidazolium-based zwitterionic polymer because the carbon atom at the C2 position of imidazolium carries a considerable positive charge. Such charge makes its hydrogen an excellent hydrogen-bond donor, enabling enhanced interactions with amino acids.

### Reduced Adhesion of Human Coronavirus HCoV-OC43 on the Imidazolium-Based Zwitterionic Polymer

Repulsion of viruses under submerged aqueous conditions was also quantified to assess the ability of the imidazolium-based zwitterionic polymer to resist the adhesion of viruses under physiologically relevant conditions. The aforementioned surfaces were incubated with HCoV-OC43 virus suspensions, with the median tissue culture infectious dose (TCID50, a measure of viral titer) of 10^{7.5}/mL which is stock solution with the highest concentration, at room temperature for 30 minutes for virus to adhere. Virus attached to surface via physical adsorption and exhibited little correlation with the incubation time. Therefore, we chose a relatively short incubation time to capture the potential adhesion of virus.

The adhesion density of the virus particles was characterized using scanning electron microscope (SEM) images (FIG. 9, Part C). To ensure the statistical representativeness of our results, we took four non-overlapping SEM images on each surface with a field of vision that is 25 μm by 15 μm. That size of the field of vision was chosen to be large enough to capture a statistical average of the virus adhesion without losing the resolution required to correctly identify the virus nanoparticles, which were merely 100-200 nm on average and with a spherical shape.

As shown in FIG. 9, Part C. CP55-60 exhibited the lowest amount of virus adhesion at the end of the incubation period among all surfaces tested. Compared to the virus adhesion densities on control group surfaces, which were calculated to be 8.1×10⁶/cm² (glass), 1.4×10⁶/cm² (PVC), and 4.3×10⁵/cm² (Cu), the adhesion density was reduced by 97.4% on the surface coated with CP55-60 to 2.1×10⁵/cm² compared with the glass surface.

Previous research has indicated that zwitterionic polymers synthesized using the two-step vapor-based method can have a mild negative charge. Although negative surface charge is desirable because virus particles are also believed to be negatively charged, electrostatic repulsion is not anticipated to be the primary reason for the reduction of viral adhesion, as charge neutrality is a prerequisite for the anti-biofouling behavior demonstrated by the imidazolium zwitterionic polymers reported here. It is believed that such reduction in viral adhesion is attributed to strong hydration and charge-neutral nature of CP55-60, minimize the non-specific binding between viral particles and surface.

### Reduced Biofilm Formation and Production of Siderophores on the Imidazolium-Based Zwitterionic Polymer

In addition to the excellent antiviral performance, the imidazolium-based zwitterionic polymer also led to reduced biofilm formation. To characterize the fouling resistance of CP55-60, Pseudomonas aeruginosa, strain PAO1, was selected as the model organism for its known ability to rampantly produce biofilm and the large amount of hospitalization cases caused by PAO1 each year.

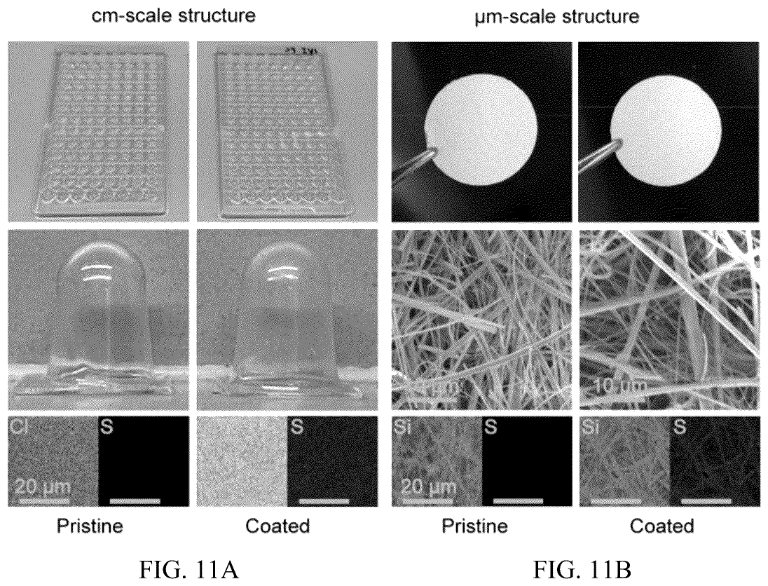

Biofilm growth was quantified using the O'Toole protocol, which has been adapted to characterize antifouling performance of planar substrates and coated surfaces. The CP55-60 coating exhibited reduced biofilm formation compared to the PVC materials commonly used in healthcare facilities, where the amount of biofilm captured on the coated surface was 16% that of PVC, measured using the crystal violet staining approach. By comparison, non-derivatized CP55 or PDVB incurred biofilm growth that was comparable to PVC (FIG. 10A). Furthermore, the reduced biofilm formation on CP55-60 was not due to its antimicrobial effect, as the liquid culture incubated with all surfaces demonstrated similar stationary OD₆₀₀ (not shown). The imidazolium-based zwitterionic coatings are distinct from extant antimicrobial coatings as bacteria were not deactivated on the zwitterionic surface. The strong hydration on zwitterionic surfaces suppresses adhesion of cells without the need for killing them. As a result, zwitterionic surfaces commonly have a much longer-lasting effect of inhibiting biofilm formation compared to antimicrobial surfaces. SEM images of the PAO1 biofilms grown on the four surfaces were captured to gain further insight into the effect of the surface chemistry on biofilm physiology (FIG. 10B). PVC, PDVB and CP55 show a thick biofilm with dense extracellular polymeric substances (EPS), whereas biofilm grown on the CP55-60 displayed sparse thread-like EPS.

The rampant PAO1 biofilm constantly secretes the virulence factors, such as pyoverdine, removing significant amounts of ferric ion from the host and causing severe toxicity to mammalian cells such as mitochondrial damage, reduced electron transfer and ATP production, and ultimately mitochondrial turnover. Inhibition of the production of microbial pyoverdine thus has the potential to mitigate the virulence from P. aeruginosa. To demonstrate that the imidazolium-based zwitterionic polymers was able to reduce the production of pyoverdine, the amount of pyoverdine in supernatant was measured by the fluorescent intensity at 460 nm, and subsequently normalized by the OD₆₀₀ to offset the potential variations in the culture conditions. Compared with CP55, PDVB or PVC surface, CP55-60 significantly reduced the production of pyoverdine, (FIG. 10C) which was attributed to the limited biofilm formation.

### Substrate-Independent and Conformal Nature of the Solvent-Free Synthesis Approach.

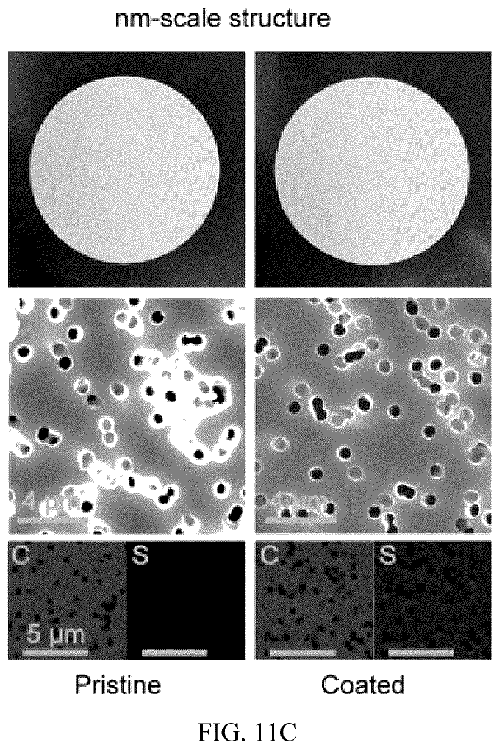

The all-dry synthesis approach described above was used to create imidazolium-based zwitterionic coatings on substrates that are (1) curved with cm-level curvature (i.e., 96-well plates, FIG. 11A), (2) microporous with convoluted 3D structures (i.e., glass fiber filters, FIG. 11B), and (3) nanoporous with aspect ratios as high as 165 (i.e., polycarbonate membranes with 800-nm pores, FIG. 11C). The substrate morphology was well preserved with a 600-nm-thick coating on the 96-well plates, a 200-nm coating on glass fiber, and a 10-nm coating on polycarbonate membranes. The thickness for each coating is less than 10% of their characteristic length to maintain their original morphology.

Successful synthesis of the CP55-60 coatings on the variety of substrates and the coating conformality were proven using SEM Energy Dispersive X-Ray Analysis (EDX), where elemental mapping of sulfur, the element that was only present in the CP55-60 coating and not in any of the substrates, indicated the presence of the coating. Furthermore, the distribution of sulfur overlapped entirely with the underlying nano- and microstructures (FIGS. 11B and 11C) on the coated substrates, implying the excellent conformality of the CP55-60 coating. The conformality, combined with the substrate-independence of this synthesis approach, pointed to the broad applications of the imidazolium-based zwitterionic polymer across a wide range of industries such as healthcare and manufacturing, and promised their reproducible synthesis and consistent antiviral and antifouling performance to mitigate public health threats.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a composition or article that “comprises”, “has”, “includes” or “contains” one or more features possesses those one or more features, but is not limited to possessing only those one or more features.

As used herein, the terms “comprising,” “has,” “including,” “containing,” and other grammatical variants thereof encompass the terms “consisting of” and “consisting essentially of.”

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

While several aspects and embodiments of the present invention have been described and depicted herein, alternative aspects and embodiments may be affected by those skilled in the art to accomplish the same objectives. Accordingly, this disclosure and the appended claims are intended to cover all such further and alternative aspects and embodiments as fall within the true spirit and scope of the invention.

1. A solid zwitterionic copolymer comprising repeat units of formulas (I) and (II): 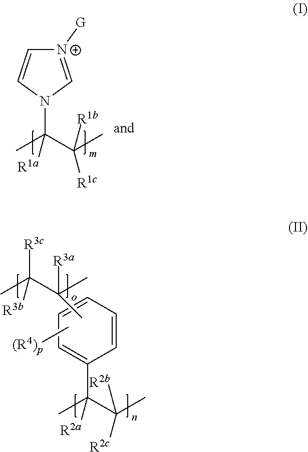
wherein
G is a moiety comprising at least one negatively charged functional group;
R^{1a}, R^{1b}, and R^{1c} are each independently selected from hydrogen, alkyl, phenyl, halo, hydroxyl, amino, nitro, and cyano;
R^{2a}, R^{2b}, and R^{2c} are each independently selected from hydrogen, alkyl, phenyl, halo, hydroxyl, amino, nitro, and cyano;
R^{3a}, R^{3b}, and R^{3c} are each independently selected from hydrogen, alkyl, phenyl, halo, hydroxyl, amino, nitro, and cyano;
R⁴ is in each instance independently selected from alkyl, phenyl, halo, hydroxyl, amino, nitro, and cyano;
m is an integer that is ≥1;
n is an integer that is ≥1;
o is an integer that is ≥1; and
p is an integer that is 0-4.

2. The copolymer according to claim 1, wherein G comprises a carboxylate anion, a sulfonate anion, a phosphonate anion, or an oxygen atom.

3. The copolymer according to claim 1, wherein the at least one negatively charged functional group is an oxygen atom.

4. The copolymer according to claim 1, wherein R^{1a}, R^{1b}, and R^{1c} are each independently selected from hydrogen and alkyl.

5. The copolymer according to claim 1, wherein R^{2a}, R^{2b}, and R^{2c} are each independently selected from hydrogen and alkyl.

6. The copolymer according to claim 1, wherein R^{3a}, R^{3b}, and R^{3c} are each independently selected from hydrogen and alkyl.

7. The copolymer according to claim 1, wherein R⁴ is in each instance independently selected from alkyl and halo.

8. The copolymer according to claim 1, wherein p is 0.

9. The copolymer according to claim 1, additionally comprising a repeat unit from a crosslinking moiety X.

10. The copolymer according to claim 9, wherein the crosslinking moiety X is selected from a unit of polymerized monomer selected from arylene, alkylene, phenylene, 1,4-phenylene, ethylene glycol dimethacrylate, ethylene glycol diacrylate, vinyl methacrylate, allyl methacrylate, maleic anhydride, 1,3,5-trivinyltrimethylcyclotrisiloxane glycidyl methacrylate, and di(ethylene glycol) divinyl ether, or any combination thereof.

11. The copolymer according to claim 1, wherein G is —(CH₂)₁₋₆SO₃⁻.

12. The copolymer according to claim 1, comprising one or more repeat units having the formula (III):

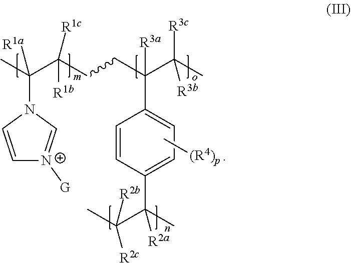

13. The copolymer according to claim 1, comprising one or more repeat units having the formula (III′):

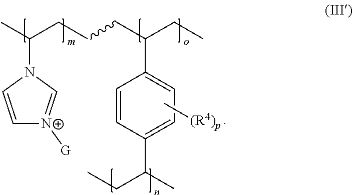

14. The copolymer according to claim 13, comprising one or more repeat units having the formula (III″)

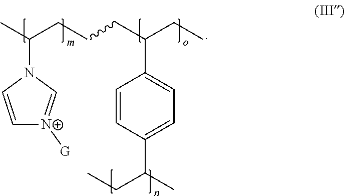

15. The copolymer according to claim 14, comprising one or more repeat units having the formula (III′″):

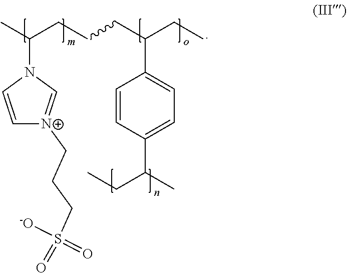

16. The copolymer according to claim 1, wherein, excluding the composition of G, the copolymer has an elemental composition having 10 to 30 molar % oxygen.

17. The copolymer according to claim 1, wherein, excluding the composition of G, the copolymer has an elemental composition having:
13 to 25% oxygen;
3 to 16% nitrogen; and
60 to 82% carbon.

18. The copolymer according to claim 1, produced by an all-dry technique.

19. The copolymer according to claim 16, produced by an all-dry technique.

20. The copolymer according to claim 1, wherein units of formulas (I′) and (II) are incorporated into an intermediate of the copolymer via initiated chemical vapor deposition (iCVD)

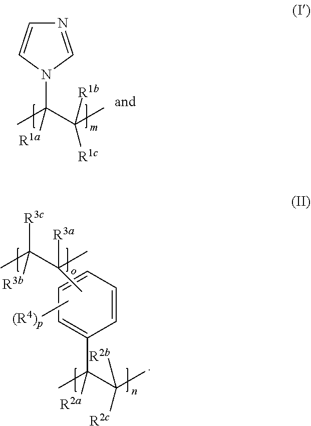

21. The copolymer according to claim 1, wherein:
units of formula (I) constitute 10 to 75 mol % of the copolymer; and
units of formula (II) constitute 25 to 90 mol % of the copolymer.

22. The copolymer according to claim 1, having a water contact angle (CA) of less than 10°.

23. A film comprising a layer of the copolymer according to claim 1, wherein the thickness of the layer is 5 nm to 100 microns.

24. The film according to claim 23, wherein the film is a conformal film.

25. The film according to claim 23, wherein the film has a water contact angle (CA) of less than 10°.

26. A composition comprising:
a coating material comprising a copolymer according to claim 1; and
a substrate;
wherein the substrate is coated with a layer of the coating material on at least one side.

27. An article comprising the composition of claim 26.

28. A method of making the copolymer according to claim 1, said method comprising:
placing a substrate in an iCVD reactor under vacuum condition;
flowing into the reactor in parallel or in sequence a plurality of materials comprising:
an inert carrier gas;
an initiator;
a first monomer that is the source of the imidazole moiety in the formula (I) repeat units; and
a second monomer that is the source of the formula (II) repeat units:
thereby forming a polymer on the substrate via iCVD, and
exposing the polymer to a negatively charged functional moiety, thereby forming the copolymer according to claim 1.

29. The method according to claim 28, wherein said exposing the polymer to a negatively charged functional moiety comprises exposing the polymer layer to a vapor of 1,3-propanesultone.

30. A method of:
protecting a substrate from viral contamination; or
decreasing, reducing, or inhibiting viral proliferation on a substrate, or
deactivating a virus on a substrate;
said method comprising applying a layer of the copolymer according to claim 1 on a substrate.

31. The method according to claim 30, wherein applying the layer of the copolymer on the substrate comprises:
placing the substrate in an iCVD reactor under vacuum condition;
flowing into the reactor in parallel or in sequence a plurality of materials comprising:
an inert carrier gas;
an initiator;
a first monomer that is the source of the imidazole moiety in the formula (I) repeat units; and
a second monomer that is the source of the formula (II) repeat units;
thereby forming a polymeric layer on at least one side of the substrate via iCVD; and
exposing the polymeric layer to a negatively charged functional moiety, thereby forming the layer of the copolymer according to claim 1 on the substrate.

32. The method according to claim 31, wherein said exposing the polymeric layer to a negatively charged functional moiety comprises exposing the polymer layer to a vapor of 1,3-propanesultone.
